(19) United States
(12) Patent Application Publication
(10) Pub. No.: US 2004/0263144 A1
(43) Pub. Date: Dec. 30, 2004

(54) Reference voltage generator with supply voltage and temperature immunity

(76) Inventors: Chien-Chung Tseng, Hsinchu (TW); Chih-Neng Hsu, Hsinchu (TW)

Correspondence Address: Kenton R. Mullins, Stout, Uxa, Buyan & Mullins, LLP, Suite 300, 4 Venture, Irvine, CA, 92618, US

(21) Appl. No.: 10/608,612

(22) Filed: Jun. 27, 2003

(51) Int. Cl. G05F 3/16

(52) U.S. Cl. 323/313

(57) ABSTRACT

A reference voltage generator includes a first current source, an output current mirror, an output device, and a shunt device. The first current source generates a first current and has a first temperature coefficient. The output current mirror mirrors the first current and generates a second current in response to the first current. The output device provides a reference voltage in response to the second current. The shunt device has a second temperature coefficient that is complementary to the first temperature coefficient, and is operatively coupled in parallel with the output device.

### BACKGROUND OF THE INVENTION

1. Field of the Invention

The present invention relates generally to reference voltage generators, and more particularly, to reference voltage generators with supply voltage and temperature immunity.

2. Description of Related Art

Reference voltage generators have traditionally been temperature dependent. As temperature changes, a reference voltage produced by the reference voltage generator has traditionally changed accordingly. A need thus exists in the prior art to provide a reference voltage that is substantially unchanged as temperature changes.

### SUMMARY OF THE INVENTION

The present invention addresses the above-stated need by providing a reference voltage generator that provides a reference voltage at a reference voltage node. The reference voltage can be substantially invariant with respect to temperature. A reference voltage with supply voltage and temperature immunity is generated by applying the gate-source voltage difference of a PMOS transistor across a first resistive element to generate a current and mirroring the current on a second resistive element connected with an NMOS transistor in parallel to compensate for the variations in the current of the PMOS transistor.

Any feature or combination of features described herein are included within the scope of the present invention provided that the features included in any such combination are not mutually inconsistent as will be apparent from the context, this specification, and the knowledge of one skilled in the art. For purposes of summarizing the present invention, certain aspects, advantages and novel features of the present invention have been described herein. Of course, it is to be understood that not necessarily all such aspects, advantages or features will be embodied in any particular embodiment of the present invention. Additional advantages and aspects of the present invention are apparent in the following detailed description and claims.

### BRIEF DESCIRPTION OF THE DRAWINGS

FIG. 1 is a schematic diagram of a first circuit in accordance with an illustrated embodiment of the present invention;

FIG. 2 is a schematic diagram of a second circuit in accordance with another illustrated embodiment of the present invention;

FIG. 3 is a simulation depicting a potential of node C as a function of time in accordance with an illustrated embodiment of the present invention; and

FIG. 4 is a collection of graphs showing various voltages as a function of time in accordance with an illustrated embodiment of the present invention.

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the manufacture of a reference voltage generator. The present invention may be practiced in conjunction with various circuits that require a reference voltage, including several techniques that are conventionally used in the art, and only so much of the commonly practiced process steps are included herein as are necessary to provide an understanding of the present invention. The present invention has applicability in the field of supply voltages and temperature immunity in general. For illustrative purposes, however, the following description pertains to a reference voltage generator with supply voltage and temperature immunity.

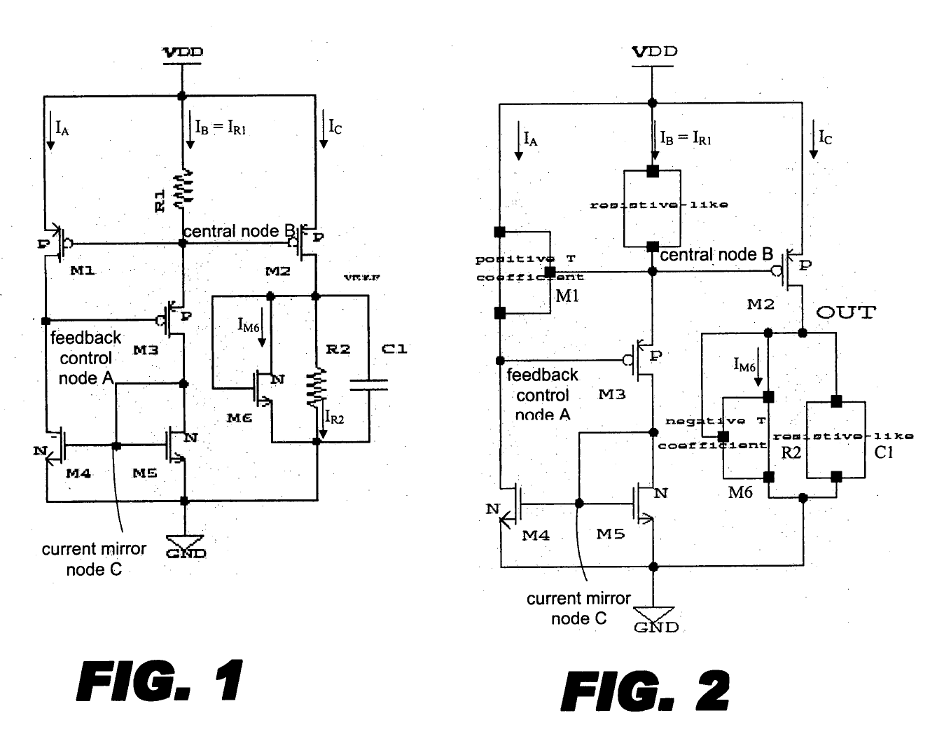

Referring now to FIG. 1, a first circuit in accordance with an illustrated embodiment of the present invention is shown, comprising a first current path I_{A} including a current source transistor M₁ and a feedback transistor M₄; a compensation current path I_{B} including a first resistor R₁, a feedback control transistor M₃, and a feedback-generating transistor M₅; and a second current path I_{C} including an output transistor M₂, a thermal coupling transistor M₆, a second resistor R₂, and an output capacitor C₁.

Referring now to the first current path I_{A}, the current source transistor M₁ is a PMOS transistor having a source terminal coupled to a supply signal VDD, a drain terminal coupled to a feedback control node A, and a gate terminal coupled to a central node B. The feedback transistor M₄ is an NMOS transistor having a drain terminal coupled to the feedback control node A, a source terminal coupled to a ground node, and a gate terminal coupled to a current mirror node C.

Referring now to the compensation current path I_{B}, the first resistor R₁ is coupled between the supply signal V_{DD} and the central node B. The feedback control transistor M₃ is a PMOS transistor having a source terminal coupled to the central node B, a drain terminal coupled to the current mirror node C, and a gate terminal coupled to the feedback control node A. The feedback-generating transistor M₅ is an NMOS transistor having a source terminal coupled to the ground node, a drain terminal coupled to the current mirror node C, and a gate terminal also coupled to the current mirror node C.

Referring now to the second current path I_{C}, the output transistor M₂ is a PMOS transistor having a source terminal coupled to the supply signal V_{DD}, a drain terminal coupled to an output node V_{REF}, and a gate terminal coupled to the central node B. The thermal coupling transistor M₆ is an NMOS transistor having a source terminal coupled to the ground node, and both a drain terminal and a gate terminal coupled to the output node V_{REF}. The second resistor R₂ and the output capacitor C₁ are coupled between the output node V_{REF} and the ground node, such that the second resistor R₂ and the output capacitor C₁ are in parallel with the gate-source and drain-source voltages of the thermal coupling transistor M₆.

Power-up

When power is initially applied to the circuit and the supply signal V_{DD} begins to ramp up to its operational voltage, the voltage at the central node B follows the voltage of the supply signal V_{DD} across the first resistor R1. Current begins to flow through the compensation current path I_{B} to the central node B, capacitively increasing the voltage of the central node B. Similarly, when power is initially applied to the circuit and the supply signal V_{DD} begins to ramp up to its operational voltage, the voltage at the feedback control node A has a voltage approximately equal to ground voltage. As voltage of the central node B increases while the voltage at the feedback control node A remains approximately zero, current flows through the feedback control transistor M₃ to the current mirror node C, capacitively increasing the voltage of the current mirror node C. As the voltage of the current mirror node C increases, current begins to flow through the feedback-generating transistor M₅.

When a current path through the feedback control transistor M₃ and the feedback-generating transistor M₅ begins to form between the central node B and ground through the compensation current path I_{B}, any residual capacitive charge at the central node B is discharged. As the voltage at the central node B is reduced, a quiescent current begins to flow through the first resistor R1, creating a voltage difference between the supply signal V_{DD} and the central node B.

The First Current Path I_{A} and the Compensation Current Path I_{B}

Within the first current path I_{A}, the voltage difference between the supply signal V_{DD} and the central node B imposes a gate-to-source voltage V_{GS1} on the current source transistor M₁. The gate-to-source voltage V_{GS1} causes a current to flow through the current source transistor M₁ and through the first current path I_{A}. Current through the first current path I_{A} passes through the current source transistor M₁ and through the feedback transistor M₄ to ground.

Within the compensation current path I_{B}, the voltage difference between the supply signal V_{DD} and the central node B further creates a current in the compensation current path I_{B} through the first resistor R₁. In accordance with Ohm's law, the current in the compensation current path I_{B} is I_{B}=V_{GS1}/R₁. The current passes through the first resistor R₁ and through both the feedback control transistor M₃ and through the feedback-generating transistor M₅ to ground.

The reference voltage generator therefore has a first current source, i.e., the current source transistor M₁, that generates the first current I_{A}. The current source transistor M₁ has a first temperature coefficient, which is generally positive since the current source transistor M₁ is a PMOS transistor. With changes in temperature, the current source transistor M₁ can apply a gate-source voltage difference on the first resistive element (i.e., the first resistor R₁), generate a first current through the current source transistor M₁, and conduct a compensation current through the first resistor R1.

The compensation current varies in response to the first current, such that a one-to-one correspondence exists between the compensation current and the first current. In other words, for any given first current through the current source transistor M₁, only one compensation current through the first resistor R₁ is possible. Moreover, as the first current through the current source transistor M₁ increases, the compensation current through the first resistor R₁ also increases; and as the first current through the current source transistor M₁ decreases, the compensation current through the first resistor R₁ also decreases.

Advantageously, the feedback-generating transistor M₅ and the feedback transistor M₄ form a feedback current mirror that stabilizes the current through the first current path I_{A} and the current through the compensation current path I_{B}. If the current through the compensation current path I_{B} increases, for example, then the gate-to-source voltage of the feedback-generating transistor M₅ increases accordingly, increasing the gate-to-source voltage of the feedback transistor M₄ across the feedback current mirror formed by the feedback-generating transistor M₅ and the feedback transistor M₄. The consequently greater voltage at the feedback control node A restricts the current through the feedback control transistor M₃, curtailing the current through the compensation current path I_{B}.

Similarly, if the current through the compensation current path I_{B} decreases, then the gate-to-source voltage of the feedback-generating transistor M₅ decreases accordingly, decreasing the gate-to-source voltage of the feedback transistor M₄ across the feedback current mirror formed by the feedback-generating transistor M₅ and the feedback transistor M₄. The consequently lower voltage at the feedback control node A allows more current to flow through the feedback control transistor M₃, increasing the current through the compensation current path I_{B}.

The feedback control transistor M₃ is a feedback element that conducts the compensation current such that the compensation current varies inversely in response to the first current. In other words, as the first current increases, raising the voltage of the feedback control node A, the compensation current decreases, and as the first current decreases, lowering the voltage of the feedback control node A, the compensation current increases. The feedback element and the first resistor R₁ (i.e., a compensation element) operate to restore the first current to a substantially constant first current.

Thus, there are two independent relationships between the first current path I_{A} and the compensation current path I_{B}. First, the voltage across the gate and source terminals of the current source transistor M₁ (i.e., the voltage difference between the supply signal V_{DD} and the central node B) is equal to the voltage across the first resistor R. Second, the current through the feedback-generating transistor M₅ is related to the feedback transistor M₄ across the feedback current mirror. The two independent relationships provide a restorative feedback that inhibits fluctuations in the current through the first current path I_{A} (and the current through the compensation current path I_{B}). Since the gate and drain terminals of M5 are connected together, the Vgs of M5 equals the Vds (i.e., the voltage difference between the drain terminal and the gate terminal) of M5. The Vds of the transistor M5 is greater than Vgs−Vt. Therefore M5 will operate within the saturation region. Since M5 operates within the saturation region, Ids=k(W/L)(Vgs−Vt)(Vgs−Vt). In other words, if the dimensions of M4 and M5 are equal, then the current through M4 will be equal to that of M5.

The First Current Path I_{A} and the Second Current Path I_{C}

The voltage difference V_{GS1} of the current source transistor M₁ is further mirrored on the output transistor M₂ to produce a current through the second current path I_{C}. In other words, the current source transistor M₁ and the output transistor M₂ form an output current mirror that produces a current through the second current path I_{C}.

A current divider serves to stabilize the voltage at the output node V_{REF} by stabilizing the current through the thermal coupling transistor M₆ and through the second resistor R₂. The second resistor R₂ is an output device that is operative to provide a reference voltage in response to the second current. The current through the second current path I_{C} is divided between the thermal coupling transistor M₆ and the second resistor R₂. The voltage at the output node V_{REF} is applied as a gate-to-source voltage of the thermal coupling transistor M₆, causing a current I_{M6} to flow through the thermal coupling transistor M₆. The voltage at the output node V_{REF} is also applied across the second resistor R₂, corresponding to flow of a current I_{R2} through the second resistor R₂.

When the output capacitor C₁ draws no current, the current I_{M6} through the thermal coupling transistor M₆ and the current I_{R2} through the second resistor R₂ may be added together to total the current through the second current path I_{C}. If the voltage at the output node V_{REF} increases, the resulting increase in gate-to-source voltage across the thermal coupling transistor M₆ draws more current through the thermal coupling transistor M₆, attenuating the current through the second resistor R₂ and thereby restoring voltage at the output node V_{REF}.

Similarly, if the voltage at the output node V_{REF} decreases, the resulting decrease in gate-to-source voltage across the thermal coupling transistor M₆ restricts current through the thermal coupling transistor M₆ and diverts more of the current through the second current path I_{C} toward the second resistor R₂, thereby restoring the voltage at the output node V_{REF}. Since the current-to-voltage relationship of the thermal coupling transistor M₆ is independent of the current-to-voltage relationship of the second resistor R₂, while the voltages (the voltage at the output node V_{REF}) are identical and the current must total the current through the second current path I_{C}, the two independent current-to-voltage relationships provide a restorative feedback that maintains the voltage at the output node V_{REF} substantially constant.

The temperature dependence of the current source transistor M₁ is removed by compensation with the thermal coupling transistor M₆, in combination with the first resistor R₁ and the second resistor R₂. The current source transistor M₁ and the thermal coupling transistor M₆ have complementary thermal coefficients. The current source transistor M₁ is a PMOS transistor, and consequently may be expected to have a positive temperature coefficient. As temperature increases, current I_{A} through the current source transistor M₁ may be expected to increase. The increase in current is mirrored into the second current path I_{C} across the output current mirror formed by the current source transistor M₁ and the output transistor M₂, increasing the current through the parallel combination of the thermal coupling transistor M₆ and the second resistor R₂. Without temperature compensation, the output reference voltage would vary with V_{GS1}, in accordance with the relationship:

V_{REF}=V_{GS1}*(R₂/R₁), or

∂V_{REF}/∂T=(R₂/R₁) (∂V_{GS1}/∂T)>0, where T=temperature.

The thermal coupling transistor-like element M6 provides the necessary thermal compensation to maintain the output reference voltage regardless of thermal variations in VGS1. The thermal coupling transistor-like element M6 is a PMOS transistor, and consequently may be expected to have a positive temperature coefficient. As temperature increases, current through the thermal coupling transistor-like element M6 may be expected to increase, shunting a greater current from the second resistor R2 and allowing the voltage across the second resistor R2 to remain constant despite a greater current through the first resistor R1. Similarly, as temperature decreases, current through the thermal coupling transistor-like element M6 may be expected to decrease, diverting a greater portion of the first current from the first resistor R1 into the second resistor R2 and (again) allowing the voltage across the second resistor R2 to remain constant despite a greater current through the first resistor R1. However, the increased current flow through the second resistor R₂ will increase the voltage across the second resistor R₂, thereby increasing current flow through the thermal coupling transistor M₆ and offsetting the temperature-induced decrease of current through the thermal coupling transistor M₆. The thermal coupling transistor M₆ is thus a shunt device that has a temperature coefficient which is complementary to the first temperature coefficient, being operatively coupled in parallel with the second resistor R2 and being operative to restore the reference voltage in response to temperature-dependent variations in the first current.

Threshold Voltage Drops

An examination of various threshold voltage drops through the circuit provides additional insight into the operation of the circuit. Across either the current source transistor M₁ or the output transistor M₂, the voltage of the central node B is one PMOS threshold voltage drop below the voltage of the supply signal V_{DD}. Across either the current source transistor M₁ or the feedback control transistor M₃, the feedback control node A is one PMOS threshold voltage drop below the voltage of the central node B, and across the output transistor M₂ the output node V_{REF} is one PMOS threshold voltage drop below the voltage of the central node B. If the current source transistor M₁, the output transistor M₂, and the feedback control transistor M₃ are fabricated from a uniform doping concentration and are symmetric with respect to drain and source, then the voltage at the feedback control node A is equivalent to the voltage at the output node V_{REF}.

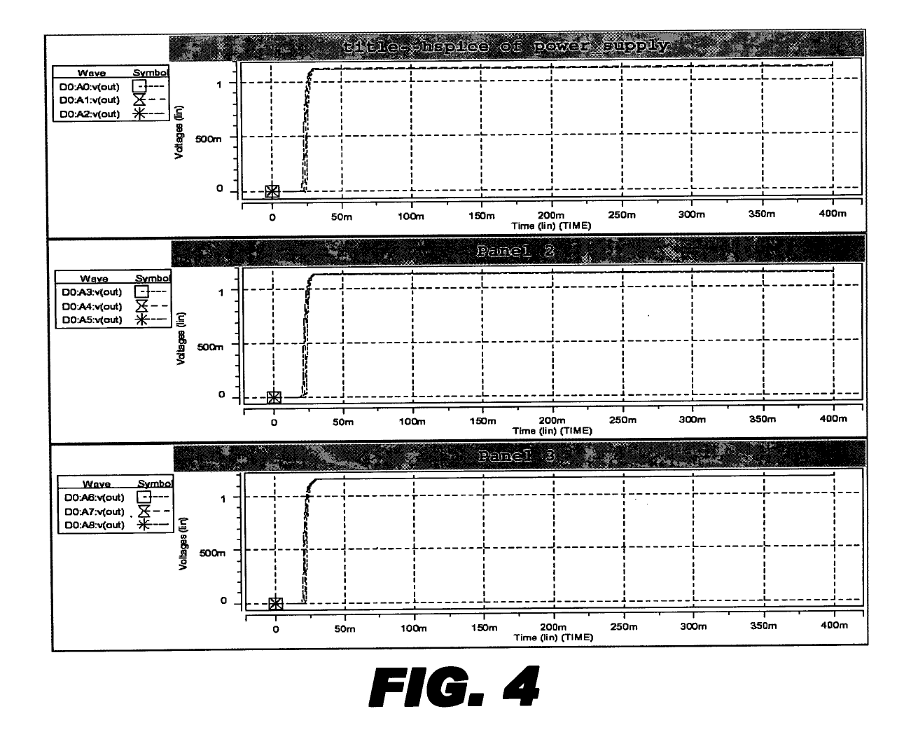

Across the feedback-generating transistor M₅, which is an NMOS transistor whose gate terminal is connected to its drain terminal and whose source terminal is connected to ground, the voltage of the current mirror node C is one NMOS threshold voltage drop above ground. FIG. 3 is simulation depicting a potential of node C as a function of time wherein a voltage of node C is about 1.2 volts. In the plot, D1:A0:v(c) corresponds to a scenario wherein VDD is 3.0 volts at a temperature of −25 C; D1:A1v(c) corresponds to a scenario wherein VDD is 3.0 volts at a temperature of 25 C; and D1:A3v(c) corresponds to a scenario wherein VDD is 3.0 volts at a temperature of 85 C.

Across the thermal coupling transistor M₆, which is an NMOS transistor whose gate terminal is connected to its drain terminal and whose source terminal is connected to ground, the voltage of the output reference node V_{REF} can be interpreted to be two NMOS threshold voltage drops above ground. Thus, a sequence of threshold voltage drops from the supply signal V_{DD} to ground includes two NMOS threshold voltage drops and two PMOS threshold voltage drops. Any positive temperature coefficient of the PMOS transistors can be compensated by a corresponding negative temperature coefficient of the NMOS transistors, resulting in a substantially temperature-independent total voltage drop between the supply signal V_{DD} and ground. As mentioned, the voltage of node V_{REF} is equal to I_{R2}*R2. In the illustrated embodiment wherein the value of R2 is fixed, if I_{R2} is also fixed, then the voltage of node V_{REF} is stable. In accordance with current mirror principles, I_{A} is equal to I_{C}. I_{C} in turn is equal to I_{R2}+I_{M6}. When the components of M1 and M6 are set to have the same or about the same temperature coefficients (e.g., all positive or all negative), then when I_{A} increases I_{M6} increases also, and vice versa. This behavior can facilitate a stabilization of I_{R2} and V_{REF}.

Referring now to FIG. 4, a collection of graphs shows various voltage waveforms as a function of time in accordance with the illustrated embodiment of the present invention, wherein v(out) in each plot denotes the potential of the output reference node V_{REF}. In the first panel of FIG. 4, D0:A0:v(out) corresponds to a scenario wherein VDD is 3.0 volts at a temperature of −25 C, yielding a relatively slow corner characteristic; D0:A1:v(out) corresponds to a scenario wherein VDD is 3.0 volts at a temperature of 25 C, generating a relatively slow corner characteristic; and D1:A2:v(out) corresponds to a scenario wherein VDD is 3.0 volts at a temperature of 85 C, yielding a relatively slow corner characteristic. In the second panel, D0:A3:v(out) corresponds to a scenario wherein VDD is 3.3 volts at a temperature of −25 C, generating a typical corner characteristic; D0:A4:v(out) corresponds to a scenario wherein VDD is 3.3 volts at a temperature of 25 C, yielding a typical corner characteristic; and D0:A5:v(out) corresponds to a scenario wherein VDD is 3.3 volts at a temperature of 85 C, generating a typical corner characteristic. In the third panel of FIG. 4, D1:A6:v(out) corresponds to a scenario wherein VDD is 3.7 volts at a temperature of −25 C, yielding a relatively fast corner characteristic; D0:A7:v(out) corresponds to a scenario wherein VDD is 3.7 volts at a temperature of 25 C, yielding a relatively fast corner characteristic; and D1:A8:v(out) corresponds to a scenario wherein VDD is 3.7 volts at a temperature of 85 C, generating a relatively fast corner characteristic.

Output Capacitor C1

With further reference to FIG. 1, the output capacitor C₁ improves the stability of the output node V_{REF}. The output capacitor C₁ and the second resistor R₂ form an RC circuit that serves to stabilize the output reference voltage at the output node V_{REF} by slowing variations in the output node V_{REF}.

The Second Circuit

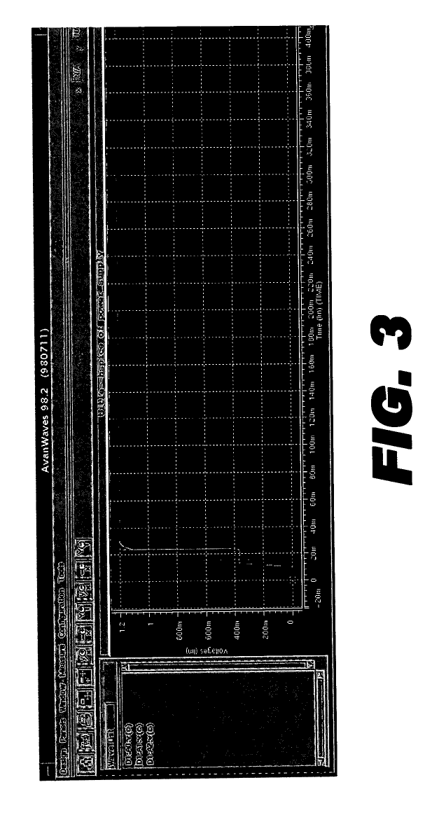

Turning now to FIG. 2, a second circuit in accordance with the illustrated embodiment of the present invention is shown. The second circuit comprises: a first current path I_{A} including a current source transistor-like element M₁ and a feedback transistor-like element M₄; a compensation current path I_{B} including a first resistive-like element R₁, a feedback control transistor-like element M₃, and a feedback-generating transistor-like element M₅; and a second current path I_{C} including an output transistor-like element M₂, a thermal coupling transistor-like element M₆, a second resistive-like element R₂, and an output capacitor-like element C₁.

Referring now to the first current path I_{A}, the current source transistor-like element M₁ can be, for example, a PMOS transistor having a source terminal coupled to a supply signal V_{DD}, a drain terminal coupled to a feedback control node A, and a gate terminal coupled to the central node B. The feedback transistor-like element M₄ can be, for example, an NMOS transistor having a drain terminal coupled to the feedback control node A, a source terminal coupled to a ground node, and a gate terminal coupled to a current mirror node C.

Referring now to the compensation current path I_{B}, the first resistive-like element R₁ is coupled between the supply signal V_{DD} and the central node B. The feedback control transistor-like element M₃ can be, for example, a PMOS transistor having a source terminal coupled to the central node B, a drain terminal coupled to the current mirror node C, and a gate terminal coupled to the feedback control node A. The feedback-generating transistor-like element M₅ can be, for example, an NMOS transistor having a source terminal coupled to the ground node, a drain terminal coupled to the current mirror node C, and a gate terminal also coupled to the current mirror node C.

Referring now to the second current path I_{C}, the output transistor-like element M₂ can be, for example, a PMOS transistor having a source terminal coupled to the supply signal V_{DD}, a drain terminal coupled to the output node V_{REF}, and a gate terminal coupled to the central node B. The thermal coupling transistor-like element M₆ can be, for example an NMOS transistor having a source terminal coupled to the ground node, and both a drain terminal and a gate terminal coupled to the output node V_{REF}. The second resistive-like element R₂ and the output capacitor-like element C₁ are coupled between the output node V_{REF} and the ground node, such that the second resistive-like element R₂ and the output capacitor-like element C₁ are in parallel with the gate-source and drain-source voltages of the thermal coupling transistor-like element M₆.

Power-up

When power is initially applied to the second circuit (i.e., the circuit of FIG. 2) and the supply signal V_{DD} begins to ramp up to its operational voltage, the voltage at the central node B follows the voltage of the supply signal V_{DD} across the first resistive-like element R1. Current begins to flow through the compensation current path I_{B} to the central node B, capacitively increasing the voltage of the central node B. Similarly, when power is initially applied to the second circuit and the supply signal V_{DD} begins to ramp up to its operational voltage, the voltage at the feedback control node A has a voltage approximately equal to ground voltage. As voltage of the central node B increases while the voltage at the feedback control node A remains approximately zero, current flows through the feedback control transistor-like element M₃ into the current mirror node C, capacitively increasing the voltage of the current mirror node C. As the voltage of the current mirror node C increases, current begins to flow through the feedback-generating transistor-like element M₅.

When a current path through the feedback control transistor-like element M₃ and the feedback-generating transistor-like element M₅ begins to form between the central node B and ground through the compensation current path I_{B}, any residual capacitive charge at the central node B is discharged. As the voltage at the central node B is reduced, a quiescent current begins to flow through the first resistive-like element R1, creating a voltage difference between the supply signal V_{DD} and the central node B.

The First Current Path I_{A} and the Compensation Current Path I_{B}

Within the first current path I_{A}, the voltage difference between the supply signal V_{DD} and the central node B imposes a gate-to-source voltage V_{GS1} on the current source transistor-like element M₁. The gate-to-source voltage V_{GS1} causes a current to flow through the current source transistor-like element M₁ and through the first current path I_{A}. Current through the first current path I_{A} passes through the current source transistor-like element M₁ and through the feedback transistor-like element M₄ to ground.

Within the compensation current path I_{B}, the voltage difference between the supply signal V_{DD} and the central node B also creates a current in the compensation current path I_{B} through the first resistive-like element R₁. In accordance with Ohm's law, the current in the compensation current path I_{B} is I_{B}=V_{GS1}/R₁. The current passes through the first resistive-like element R₁ and through both the feedback control transistor-like element M₃ and through the feedback-generating transistor-like element M₅ to ground.

Advantageously, the feedback-generating transistor-like element M₅ and the feedback transistor-like element M₄ form a feedback current mirror that stabilizes the current through the first current path I_{A} and the current through the compensation current path I_{B}. If the current through the compensation current path I_{B} increases, for example, then the gate-to-source voltage of the feedback-generating transistor-like element M₅ increases accordingly, increasing the gate-to-source voltage of the feedback transistor-like element M₄ across the feedback current mirror formed by the feedback-generating transistor-like element M₅ and the feedback transistor-like element M₄. The consequently greater voltage at the feedback control node A restricts the current through the feedback control transistor-like element M₃, curtailing the current through the compensation current path I_{B}.

Similarly, if the current through the compensation current path I_{B} decreases, then the gate-to-source voltage of the feedback-generating transistor-like element M₅ decreases accordingly, decreasing the gate-to-source voltage of the feedback transistor-like element M₄ across the feedback current mirror formed by the feedback-generating transistor-like element M₅ and the feedback transistor-like element M₄. The consequently lower voltage at the feedback control node A allows more current to flow through the feedback control transistor-like element M₃, increasing the current through the compensation current path I_{B}.

Thus, there are two independent relationships between the first current path I_{A} and the compensation current path I_{B}. First, the voltage across the gate and source terminals of the current source transistor-like element M₁ (i.e., the voltage difference between the supply signal V_{DD} and the central node B) is equal to the voltage across the first resistive-like element R₁. Second, the current through the feedback-generating transistor-like element M₅ is related to the feedback transistor-like element M₄ across the feedback current mirror. The two independent relationships provide a restorative feedback that maintains the current through the first current path I_{A} (and the current through the compensation current path I_{B}) substantially constant.

The First Current Path I_{A} and the Second Current Path I_{C}

The voltage difference VGS₁ of the current source transistor-like element M₁ is further mirrored on the output transistor-like element M₂ to produce a current through the second current path I_{C}. In other words, the current source transistor-like element M₁ and the output transistor-like element M₂ form an output current mirror that produces a current through the second current path I_{C}.

A current divider serves to stabilize the voltage at the output node V_{REF} by stabilizing the current through the thermal coupling transistor-like element M₆ and through the second resistive-like element R₂. The current through the second current path I_{C} is divided between the thermal coupling transistor-like element M₆ and the second resistive-like element R₂. The voltage at the output node V_{REF} is applied as a gate-to-source voltage of the thermal coupling transistor-like element M₆, causing a current I_{M6} to flow through the thermal coupling transistor-like element M₆. The voltage at the output node V_{REF} is also applied across the second resistive-like element R₂, causing a current I_{R2} to flow through the second resistive-like element R₂.

When the output capacitor-like element C₁ draws no current, the current I_{M6} through the thermal coupling transistor-like element M₆ and the current I_{R2} through the second resistive-like element R₂ may be added together to total the current through the second current path I_{C}. If the voltage at the output node V_{REF} increases, the resulting increase in gate-to-source voltage across the thermal coupling transistor-like element M₆ draws more current through the thermal coupling transistor-like element M₆, attenuating the current through the second resistive-like element R₂ and thereby restoring voltage at the output node V_{REF}.

Similarly, if the voltage at the output node V_{REF} decreases, the resulting decrease in gate-to-source voltage across the thermal coupling transistor-like element M₆ restricts current through the thermal coupling transistor-like element M₆ and diverts more of the current through the second current path I_{C} toward the second resistive-like element R₂, thereby restoring the voltage at the output node V_{REF}. Since the current-to-voltage relationship of the thermal coupling transistor-like element M₆ is independent of the current-to-voltage relationship of the second resistive-like element R₂, while the voltages (the voltage at the output node V_{REF}) are identical and the current must total the current through the second current path I_{C}, the two independent current-to-voltage relationships provide a restorative feedback that maintains the voltage at the output node V_{REF} substantially constant.

The temperature dependence of the current source resistive-like element M₁ is removed by compensation with the thermal coupling transistor-like element M₆, in combination with the first resistive-like element R₁ and the second resistive-like element R₂. The current source transistor-like element M₁ and the thermal coupling transistor-like element M₆ have complementary thermal coefficients. The current source transistor-like element M₁ is a PMOS transistor, and consequently may be expected to have a positive temperature coefficient. As temperature increases, current in the first current path I_{A} through the current source transistor-like element M₁ may be expected to increase. The increase in current is mirrored into the second current path I_{C} across the output current mirror formed by the current source transistor-like element M₁ and the output transistor-like element M₂, increasing the current through the parallel combination of the thermal coupling transistor-like element M₆ and second resistive-like element R₂. Without temperature compensation, the output reference voltage would vary with V_{GS1}, in accordance with the relationship:

V_{REF}=V_{GS1}*(R₂/R₁), or

∂V_{REF}/∂T=(R₂/R₁) (∂V_{GS1}/∂T)>0, where T=temperature.

The thermal coupling transistor-like element M₆ provides the necessary thermal compensation to maintain the output reference voltage regardless of thermal variations in V_{GS1}. The thermal coupling transistor-like element M₆ is an NMOS transistor, and consequently may be expected to have a negative temperature coefficient. As temperature increases, current through the thermal coupling transistor-like element M₆ may be expected to decrease, and consequently greater current is directed through the second transistor R₂. Since the increase in temperature has restricted the ability of the thermal coupling transistor-like element M₆ to conduct current, even more of the current passes through the second resistive-like element R₂. However, as mentioned above in connection with the FIG. 1 circuit, the increased current flow through the second resistive-like element R₂ will increase the voltage across the second resistive-like element R₂, thereby increasing current flow through the thermal coupling transistor-like element M₆ and offsetting the temperature-induced decrease of current through the thermal coupling transistor-like element M₆.

Output Capacitor-like Element C1

Further, output capacitor-like element C₁ improves the stability of the output node V_{REF}. The output capacitor-like element C₁ and the second resistive-like element R₂ form an RC circuit that serves to stabilize the output reference voltage at the output node V_{REF} by slowing variations in the output node V_{REF}.

In view of the foregoing, it will be understood by those skilled in the art that the methods of the present invention can provide a reference voltage with substantial temperature immunity in response to a supply voltage. The above-described embodiments have been provided by way of example, and the present invention is not limited to these examples. Multiple variations and modifications to the disclosed embodiments will occur, to the extent not mutually exclusive, to those skilled in the art upon consideration of the foregoing description. For example, various resistive-like element combinations can replace the first and second resistive-like elements. Moreover, various combinations of the current source transistor-like element and the thermal coupling transistor-like element with opposite temperature coefficients can be implemented. Additionally, other combinations, omissions, substitutions and modifications will be apparent to the skilled artisan in view of the disclosure herein. Accordingly, the present invention is not intended to be limited by the disclosed embodiments, but is to be defined by reference to the appended claims.

What is claimed is:

1. A reference voltage generator comprising:
a first current source operative to generate a first current, the first current source having a first temperature coefficient;
an output current mirror operatively coupled to mirror the first current and to generate a second current in response to the first current;
an output device operative to provide a reference voltage in response to the second current; and
a shunt device, having a second temperature coefficient complementary to the first temperature coefficient, operatively coupled in parallel with the output device.

2. The reference voltage generator as set forth in claim 1, wherein the first current source is a PMOS transistor coupled to apply a gate-source voltage difference on a first resistive element to generate a compensation current.

3. The reference voltage generator as set forth in claim 1, wherein the shunt device is operative to restore the reference voltage in response to variations in the first current.

4. The reference voltage generator as set forth in claim 1, wherein the shunt device is operative to restore the reference voltage in response to temperature-dependent variations in the first current.

5. The reference voltage generator as set forth in claim 1, further comprising a compensation element operative to conduct a compensation current that varies in response to the first current, such that a one-to-one correspondence exists between the compensation current and the first current.

6. The reference voltage generator as set forth in claim 5, further comprising a feedback element operative to conduct the compensation current such that the compensation current varies inversely in response to the first current, such that an inverse one-to-one correspondence exists between the first current and the compensation current, and wherein the feedback element and the compensation element operate to restore the first current to a substantially constant first current.

7. The reference voltage generator as set forth in claim 5, wherein the compensation element is a first resistive element.

8. The reference voltage generator as set forth in claim 1, further comprising a feedback element operative to conduct a compensation current that varies inversely in response to the first current, such that a one-to-one correspondence exists between the compensation current and the first current.

9. The reference voltage generator as set forth in claim 2, wherein the output device is a second resistive element coupled to be applied with the second current to generate the reference voltage.

10. The reference voltage generator as set forth in claim 9, wherein the shunt device is an NMOS transistor connected to the second resistive element in parallel to compensate for a variation of the gate-source voltage difference.

11. A method for generating a reference voltage, comprising:
generating a first current having a first temperature coefficient;
mirroring the first current and generating a second current in response to the first current;
providing a reference voltage in response to the second current; and
shunting a current having a second temperature coefficient complementary to the first temperature coefficient in parallel with the second current.

12. The method for generating a reference voltage as set forth in claim 11, wherein the generating of a first current having a first temperature coefficient includes:
applying a first gate-source voltage difference to a PMOS transistor; and
applying the first gate-source voltage difference to a first resistive element.

13. The method for generating a reference voltage as set forth in claim 11, wherein the shunting of a current having a second temperature coefficient complementary to the first temperature coefficient in parallel with the second current further includes restoring the reference voltage in response to variations in the first current.

14. The method for generating a reference voltage as set forth in claim 11, wherein the shunting of a current having a second temperature coefficient complementary to the first temperature coefficient in parallel with the second current further includes restoring the reference voltage in response to temperature-dependent variations in the first current.

15. The method for generating a reference voltage as set forth in claim 11, wherein the generating of a first current having a first temperature coefficient includes:
applying a first gate-source voltage difference to a first resistive element; and
conducting a compensation current that varies in response to the first current, such that a one-to-one correspondence exists between the compensation current and the first current.

16. The method for generating a reference voltage as set forth in claim 15, further comprising conducting the compensation current such that the compensation current varies inversely in response to the first current, such that an inverse one-to-one correspondence exists between the first current and the compensation current, and wherein a feedback element and a compensation element operate to restore the first current to a substantially constant first current.

17. The method for generating a reference voltage as set forth in claim 11, further comprising conducting a compensation current that varies inversely in response to the first current, such that a correspondence exists between the compensation current and the first current.

18. The method for generating a reference voltage as set forth in claim 12, further comprising applying the reference voltage to a second resistive element.

19. The method for generating a reference voltage as set forth in claim 18, further comprising compensating a variation of the gate-source voltage difference by applying the reference voltage to an NMOS transistor connected to the second resistive element in parallel.

20. A reference voltage generator, comprising:
a first resistive element;
a PMOS transistor coupled to apply a gate-source voltage difference on the first resistive element to generate a first current;
a current mirror for mirroring the first current to generate a second current;
a second resistive element coupled to be applied with the second current to thereby generate a reference voltage; and
an NMOS transistor connected to the second resistive element in parallel for compensating a variation of the gate-source voltage difference.

21. The reference voltage generator as set forth in claim 20, further comprising a capacitive element connected to the second resistive element in parallel.
